(19) United States
(12) Patent Application Publication
(10) Pub. No.: US 2013/0189061 A1
(43) Pub. Date: Jul. 25, 2013

(54) GRAIN CART

(71) Applicant: DAVID KLINGELHOEFER, Amherst, NE (US)

(72) Inventor: DAVID KLINGELHOEFER, Amherst, NE (US)

(21) Appl. No.: 13/356,057

(22) Filed: Jan. 23, 2012

(51) Int. Cl. A01D 90/10

(52) U.S. Cl. 414/523

(57) ABSTRACT

A grain cart including a container mounted on a wheeled frame with the container having a right side, a left side, a front end, and a rear end. In one embodiment a discharge auger extends upwardly and outwardly from the interior of the container at the right front corner of the container so that the grain is discharged from the right side of the grain cart. In another embodiment, the discharge auger is positioned forwardly of the front wall of the container with the discharge auger extending upwardly and outwardly from its lower end so that the grain is discharged from the right side of the grain cart.

### BACKGROUND OF THE INVENTION

1.

### Field of the Invention

This invention relates to a grain cart and more particularly to a grain cart having a discharge auger which discharges grain from the right side of the cart.

2. Description of the Related Art

Many different grain carts or grain wagons have been previously provided. The conventional grain cart includes a wheeled frame which has a forwardly extending hitch for connection to a tow vehicle such as a tractor. A square or rectangular container, with an open upper end, is mounted on the wheeled frame and includes a front wall, a left side wall, a rear wall, and a right side wall. In most cases, a folding discharge auger is employed to discharge the grain from the container. To the best of Applicant's knowledge, all the prior art grain carts position the discharge augers thereon so as to discharge grain from the left side of the grain cart. See for example, U.S. Pat. No. 5,100,281 wherein the folding discharge auger extends upwardly, forwardly and outwardly through the intersection of the front and left side walls.

Many of the controls for the tractor are located at the right side of the tractor which makes it very difficult for the tractor operator to manipulate the controls at the right side of the tractor while observing the discharge auger at the left side of the grain cart.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

Two embodiments of the grain cart are disclosed. In the first embodiment, a container is mounted on a wheeled frame and has a forward wall, a rearward wall, a left side wall and a right side wall. A folding discharge auger extends from the lower interior of the container upwardly, outwardly and forwardly through the intersection of the front wall and the right side wall of the container so that the discharge end of the discharge auger is positioned at the right side of the grain cart. The discharge auger may be moved from a discharge position to a folded position.

A second embodiment of the grain cart is disclosed wherein an elongated auger is positioned in the bottom of the container for conveying grain in the container forwardly through the front wall of the container. A discharge auger of the folding type is positioned forwardly of the front wall of the container and is in communication with the forward end of the discharge auger in the container. The discharge auger extends upwardly and outwardly from the right side of the container. The discharge auger of this embodiment may be moved from a discharge position to a folded position.

In both embodiments, the discharge ends of the discharge augers are located at the right side of the grain cart so that the tractor operator, who has many of the tractor controls positioned at his/her right side, may operate those controls and still observe the discharge end of the discharge augers in a convenient and comfortable manner.

It is therefore a principal object of the invention to provide a grain cart having a right side discharge.

A further object of the invention is to provide a grain cart including a folding discharge auger which extends outwardly from the right side of the grain cart which makes it more convenient for the tractor operator to manipulate the controls at the right side of the tractor while observing the discharge auger.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a front perspective view of a first embodiment of the grain cart of this invention with the discharge auger being in the discharge position;

FIG. 2 is a front view of the grain cart of FIG. 1 with the broken lines illustrating the upper end of the discharge auger in a folded stowed position;

FIG. 3 is a top elevational view of the grain cart of FIG. 1 with the discharge auger being in a folded stowed position;

FIG. 4 is a front perspective view of a second embodiment of the grain cart of this invention;

FIG. 5 is a front view of the grain cart of FIG. 4 with the broken lines illustrating the upper end of the discharge auger in a folded stowed position; and

FIG. 6 is a top elevational view of the grain cart of FIG. 4 with the discharge auger being in a folded stowed position.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

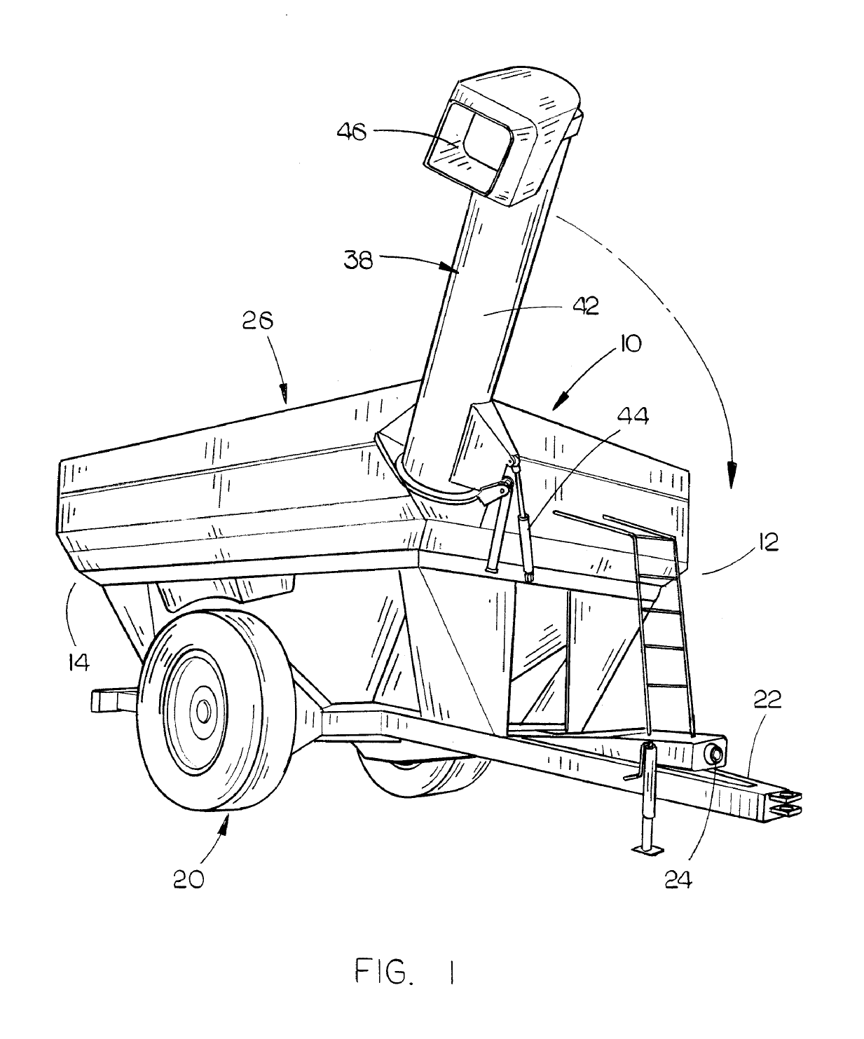

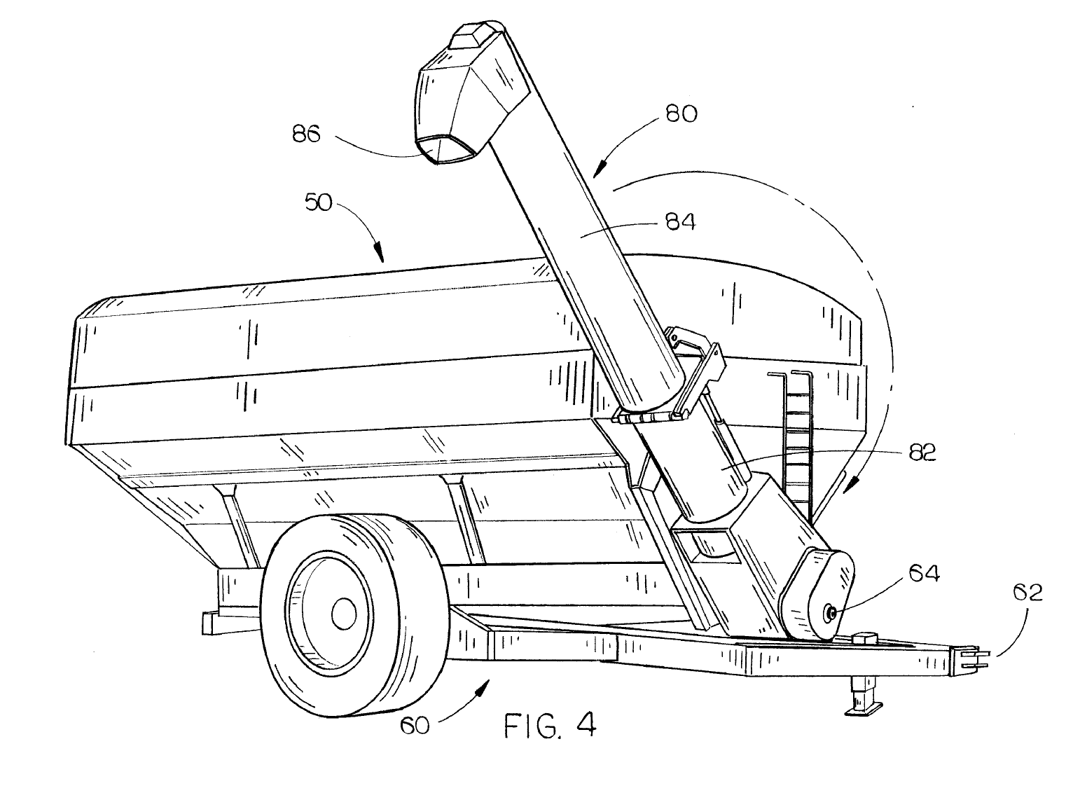

FIGS. 1-3 illustrate a first embodiment of the grain cart of this invention while FIGS. 4-6 illustrate a second embodiment of the invention. Each of the grain carts discharge grain from the right side of the grain cart.

In FIGS. 1-3, the numeral 10 refers to the first embodiment of the grain cart. Grain cart 10 will be described as having a forward end 12, a rearward end 14, a left side 16 and a right side 18. Grain cart 10 includes a conventional wheeled frame 20 having a forwardly extending hitch 22 for connection to a tow vehicle such as a tractor having some controls at the right side of the driver of the tractor. The tractor power-take-off is connected to a drive shaft or gearbox 24 in conventional fashion.

A grain container 26 with an open upper end is mounted on the wheeled frame 20 in conventional fashion. Container 26 includes a front wall 28, a rear wall 30, a left side wall 32 and a right side wall 34. Each of the walls 28, 30, 32 and 34 normally have sloped lower ends which extend downwardly and inwardly into a sump 36.

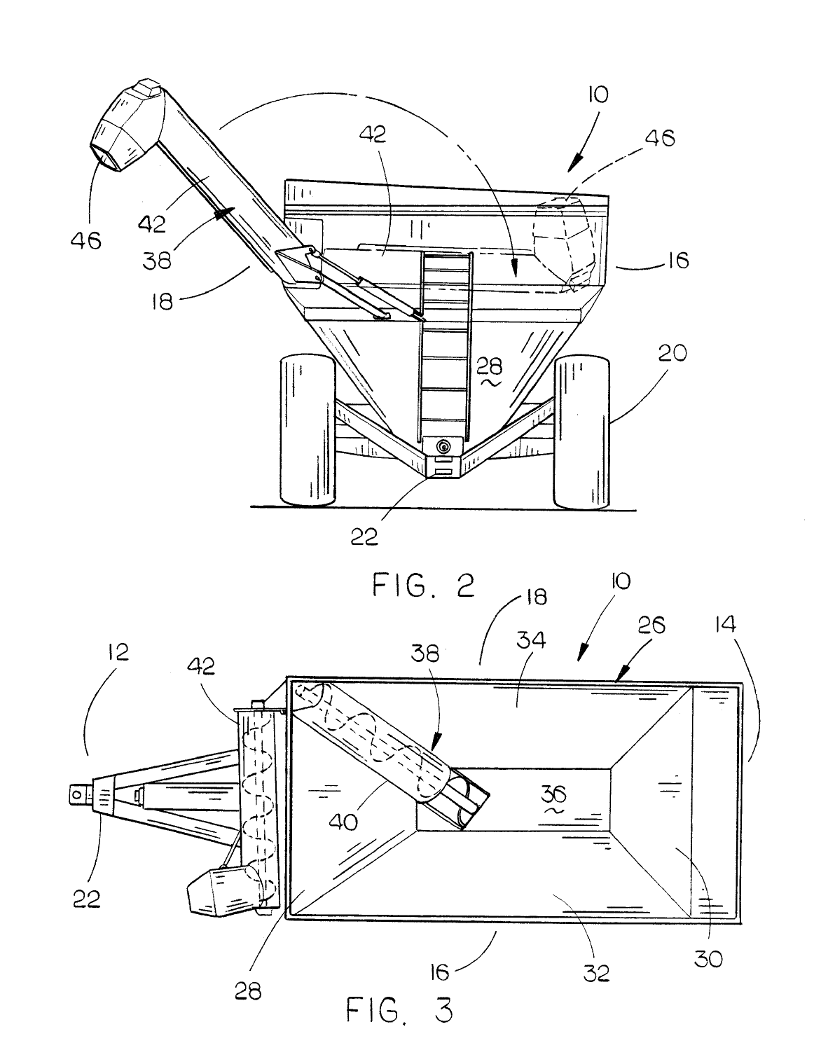

The numeral 38 refers to an elongated folding discharge auger having a lower discharge auger portion 40 and an upper discharge auger portion 42. The lower end of discharge auger portion 42 is hingedly secured to the upper end of discharge auger portion 40 in conventional fashion so that the discharge auger 38 may be pivotally moved from the operative discharge position of FIGS. 1 and 2 to the stowed or folded position of FIG. 3 by means of a hydraulic cylinder 44. The lower end of discharge auger 40 is in communication with the sump 36 with the discharge auger 38 being operated by the power-take-off of the tractor. Discharge tube portion 40 extends upwardly, forward and outwardly through the intersection of front wall 28 and right side wall 34 so that the discharge end 46 of discharge auger 38 is positioned at the forward right side of the grain cart so that the operator of the tractor may operate the tractor controls which are positioned at his/her right side, and observe the discharge end 46 of the discharge auger 38 in a convenient and comfortable manner.

Although it is preferred that the discharge auger 38 extend through the intersection of the front wall 28 and right side wall 34, discharge auger 38 could extend through right side wall 34 at the forward end thereof.

In FIGS. 4-6, the numeral 50 refers to the second embodiment of the grain cart of this invention. Grain cart 50 will be described as having a forward end 52, a rearward end 54, a left side 56 and a right side 58. Grain cart 50 includes a conventional wheeled frame 60 having a forwardly extending hitch 62 for connection to a tow vehicle such as a tractor having some controls thereof at the right side of the driver of the tractor. The tractor power-take-off is connected to a drive shaft or gear box 64 in conventional fashion.

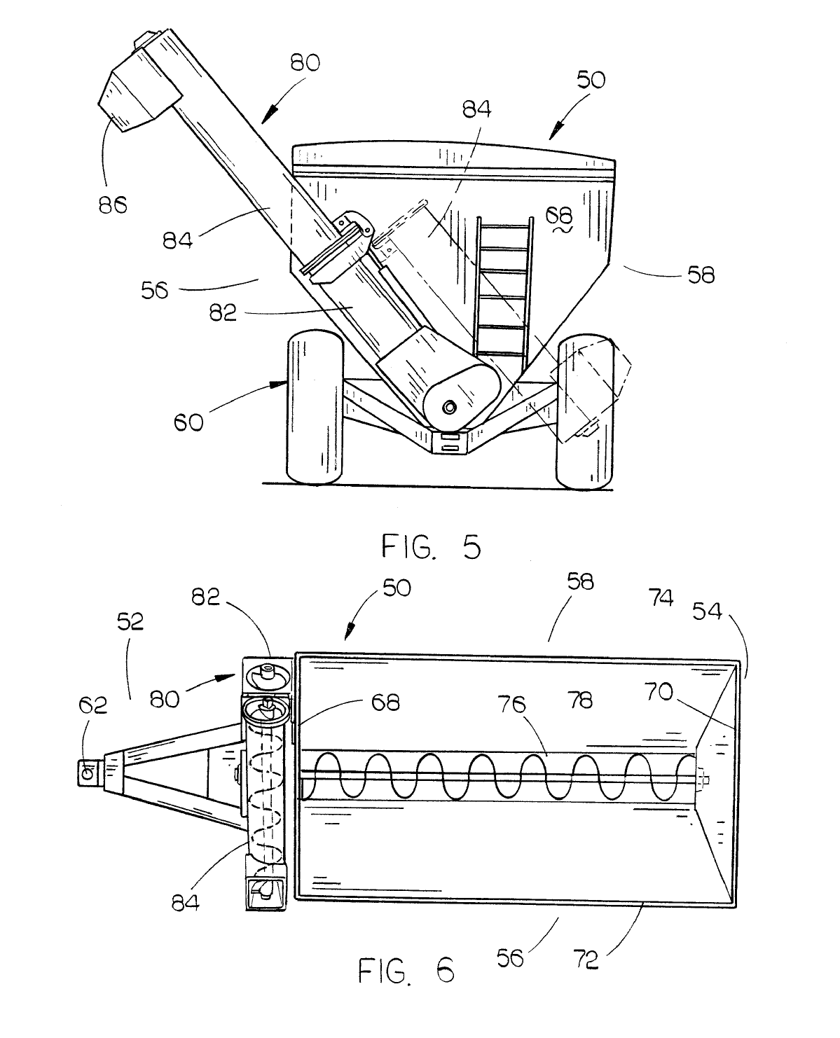

A grain container 66 with an open upper end is mounted on the wheeled frame 60 in conventional fashion. The container 66 includes a front wall 68, a rear wall 70, a left side wall 72 and a right side wall 74. The left side wall 72 and the right side wall 74 normally have sloped lower ends which extend downwardly.and inwardly into a sump 76. An elongated auger 78 is mounted in the sump 76 for conveying grain forwardly from the container outwardly through the front wall 68. The forward end of the auger 78 communicates with the lower end of a discharge auger 80 which is positioned forwardly of the front wall 68. The discharge auger 80 includes a lower discharge auger portion 82 and an upper discharge portion 84 which is hingedly connected to the upper end of discharge auger portion 82 in conventional fashion. The upper end of discharge tube portion 84 has a discharge end 86. The discharge auger 80 is movable between the discharge position of FIGS. 4 and 5 to the stowed position of FIG. 6 wherein the discharge auger portion 84 is positioned in a generally horizontal position forwardly of the front wall 68. The auger 78 and discharge auger 80 are driven by the power-take-off of the tractor.

As seen, the discharge end 86 of the discharge auger 80 is positioned outwardly of the right side of the grain cart 50 so that the operator of the tractor may operate the tractor controls, which are positioned at his/her right side and observe the discharge end 86 of the discharge auger 80 in a convenient and comfortable manner.

Thus it can be seen that the grain carts of this invention have discharge augers which discharge grain from the grain cart to the right side of the grain cart. It can therefore be seen that the grain carts of this invention accomplish all of their stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. A grain cart, comprising:
a wheeled frame having a forward end, a rearward end, a left side and a right side;
said wheeled frame having a forwardly extending hitch for connection to a tow vehicle;
a grain container mounted on said wheeled frame which has a front wall, a rear wall, a left side wall, and a right side wall defining an open top grain compartment;
and a folding discharge auger, having an intake end and a discharge end, in communication with said grain compartment for discharging grain therefrom;
said discharge auger extending from said container so that said discharge end thereof is positioned outwardly of said right side of said container;
said discharge auger being selectively movable between a discharge position and a folded position.

2. The grain cart of claim 1 wherein said discharge auger extends upwardly, forwardly and outwardly from said right side of said container adjacent the forward end thereof.

3. The grain cart of claim 1 wherein said discharge auger is positioned forwardly of said front wall of said container.

4. The grain cart of claim 3 wherein said discharge auger extends upwardly and laterally outwardly from said container.

5. A grain cart comprising:
a wheeled frame having a forward end, a rearward end, a left side and a right side;
said wheeled frame having a forwardly extending hitch for connection to a tow vehicle;
a grain container with an open upper end mounted on said wheeled frame which has an upstanding front wall with upper and lower ends, an upstanding rear wall with upper and lower ends, an upstanding left side wall having upper and lower ends, an upstanding right side wall having upper and lower ends;
a first elongated auger, having forward and rearward ends, positioned at the lower ends of said front wall, said rear wall, said left wide wall and said right side wall for conveying grain in said container outwardly through said front wall;
an elongated folding discharge auger, having upper and lower ends, positioned forwardly of said front wall of said container;
said elongated folding discharge auger being selectively movable between a discharge position and a folded position;
said lower end of said discharge auger being in communication with said forward end of said first auger;
said elongated folding discharge auger extending upwardly and laterally from said lower end thereof to a location outwardly of said right side wall when said discharge auger is in said discharge position.

6. A grain cart, comprising:
a wheeled frame having a forward end, a rearward end, a left side and a right side;
said wheeled frame having a forwardly extending hitch for connection to a tow vehicle;
a grain container with an open upper end mounted on said wheeled frame which has an upstanding front wall with upper and lower ends with a portion thereof which slopes downwardly and rearwardly to said lower end thereof, an upstanding rear wall with upper and lower ends with a portion thereof which slopes downwardly and forwardly to said lower end thereof, an upstanding left side wall with upper and lower ends with a portion thereof which slopes downwardly and inwardly to said lower end thereof, and an upstanding right side wall with upper and lower ends with a portion thereof which slopes downwardly and inwardly to said lower end thereof;
an elongated folding discharge auger having upper and lower ends;
said lower end of said discharge auger being positioned within said container at the lower ends of said front wall, said rear wall, said left side wall and said right side wall;
said discharge auger being selectively movable between a discharge position and a folded position;
said discharge auger extending upwardly and outwardly from said lower end thereof through the intersection of said front wall and said right side wall of said container so that said upper end of said discharge auger is positioned outwardly of said right side wall when said discharge auger is in said discharge position.
